(19) United States
(12) Patent Application Publication
(10) Pub. No.: US 2020/0162160 A1
(43) Pub. Date: May 21, 2020

(54) Transmitter for an Optical Free-Beam Communication System and Optical Free-Beam Communication System

(71) Applicant: Deutsches Zentrum für Luft- und Raumfahrt e.V., Koeh (DE)

(72) Inventor: Dirk Giggenbach, Puergen (DE)

(21) Appl. No.: 16/604,677

(22) PCT Filed: Apr. 12, 2018
(86) PCT No.: PCT/EP2018/059454

§ 371 Date: Oct. 11, 2019

(30) Foreign Application Priority Data
Apr. 12, 2017 (DE) 10 2017 206 347.5

(51) Int. Cl. H04B 10/118; H04B 10/112; H04B 10/50; H04B 10/67; H04B 7/185

(52) U.S. Cl. CPC H04B 10/118; H04B 10/112; H04B 7/18513; H04B 10/677; H04B 10/506

(57) ABSTRACT

Disclosed is a transmitter for an optical free-beam communication system, in particular for a data uplink to a satellite, for emission of a light signal, including a number of m data channels. In some non-limiting embodiments or aspects, the data channels may each have a different wavelength WL. Further, a multiplexer is provided for superimposition of the m data channels into a sum signal. A number of n pulse devices form a pulse signal from the sum signal, the pulse signals being chronologically offset from each other. A respective transmission device is connected with a pulse device for emitting the respective pulse signal.

Geostationary (GEO) satellites require high data rates in the up-link to transfer the data to be transmitted from the ground gateway to the satellite. From there, they are transmitted to the users on the ground as communication signals via radio transponders. The high-rate capability of these radio links between a ground station and a GEO (so-called GEO-Feeder-Link, GFL) have to become ever higher to meet the demands by the systems. At the same time the available frequency spectrum becomes ever smaller. One solution to this problem is to switch from microwave (radio) connection technology to optical directional radio.

Information about the technologies mentioned which are known from prior art can be found in the publications below:
[1] http://www.fiberdyne.com/products/itu-grid.html
[2] L. C. Andrews and R- Phillips, “Beam Propagation in Turbulent Media”, SPIE-Press
[3] Mata-Calvo et al., “Transmitter diversity verification on ARTEMIS geostationary satellite”, SPIE-Photonics West 2014

In the domain of optics no regulatory spectrum limitations exist. In addition, optical data links—as known from terrestrial fiber optic technology—allow for significantly higher data rates (currently up to 100 Gbps per channel, which could be increased about one hundredfold, if wavelength division multiplex technology—DWDM—is used) [cf. publication 1].

However, optical GFLs (OGFL) are disturbed by the atmosphere: clouds above the optical ground station (OGS) block the link to the satellite. This can be encountered to a sufficient extent by OGS diversity.

Another atmospheric influence is the refractive index turbulence (RIT) which causes an interference with the optical wavefront and thus causes intensity variations (scintillations) in the further course of propagation [cf. publication 2]. Depending on the position of the OGS and the time of day, the wavelength used and the elevation of the link (angle between the satellite, the ground station and the horizon), the RIT may cause significant field perturbations so that the fluctuation of the signal at the GEO is extremely strong. Depending on the transmission method and the RIT situation, the signal reception is strongly disturbed or even prevented thereby. The fluctuations have been established and quantified for a concrete scenario, e.g. in publication [3]. The fluctuations in received power are caused by the variations in intensity distribution at the satellite.

The temporal behavior of these signal fluctuations is a function of the temporal change of the refraction index structure. The latter is influenced primarily by wind from the side. This means that typically fade periods of 2 to 20 ms have to be expected. Such fading events are usually compensated by FEC (Forward Error Correction) algorithms and by ARQ (Automated Repeat Request) protocols, whereby, however, basic delays on the order of a multiple of the fading period (in this case about 100 ms) are caused and additional throughput losses (caused by the FEC overhead) have to be accepted.

An approach to a reduction of these fluctuations is the transmitter diversity (Tx-Div): here, the OGS emits two or more (n_{Tx}) transmission beams “Tx” parallel to the GEO. These beams propagate through various IRT volumes (for this purpose the IRT structures have to be significantly smaller than the Tx distance, which is very well guaranteed with typical structure sizes in the cm or dm range for Tx distances of about 1 m and upwards). At the satellite, they thus generate a plurality of statistically independent intensity patterns. If the wavelengths used with the different transmitters are different (the frequency difference has to be greater than the band width of the data receiver), the patterns are overlapped incoherently, i.e. the intensities add up. Often, this is generally the case with simple intensity modulations/direct reception systems (IM/DD). This results in a balance of minima and maxima, i.e. the relative fluctuations are reduced. Specifically, the scintillation index SI changes to SI(n)=SI(1)/n_{Tx}.

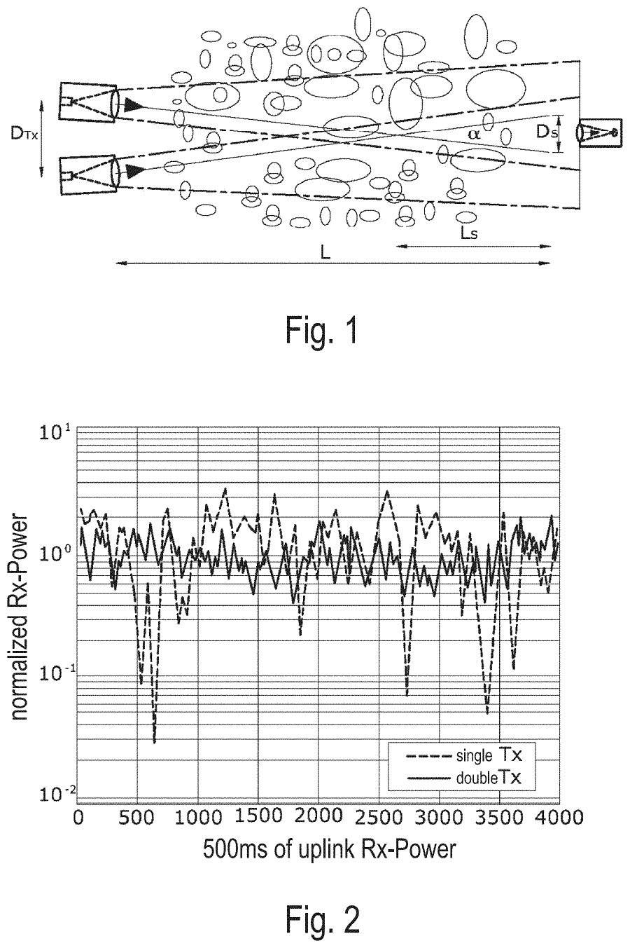

Transmitter diversity for IM/DD is an established method which has already been described and experimentally proven many times. The basic functioning is illustrated in FIG. 1. Here, two transmitters are positioned at a distance d-rx from each other and radiate towards the same target. The structure size of the turbulence cells is smaller than dm. This results in different intensity patterns which add up coherently if the frequencies of the two transmitters are far apart from each other.

Using this relatively simple technique of incoherent Tx diversity, it is possible to reduce the received power fluctuations. In particular, the reduction of the minima (i.e. avoiding strong fades) has a very advantageous effect. The received signal is stabilized thereby. The technique is already used in experimental optical satellite uplinks, e.g. in SILEX (uplink from ESA OGS on Tenerife to GEO Artemis of ESA—with up to four parallel transmission beams, and in the experiment KIODO and KODEN in uplinks to the Japanese satellite OICETS/Kirari of JAXA).

FIG. 2 illustrates an example for a received power vector of 0.5 seconds in length measured at the satellite. Here, an uplink of an optical ground station to a receiver on a geostationary satellite is evaluated once with and once without transmitter diversity (measured in the project ArtemEx). The solid line represents a signal generated by one transmitter, while the dashed line represents a signal generated by two transmitters. The latter has weaker fades and surges and is therefore better suited for data transmission.

When Tx-Div is used with an incoherent, but very broad-band transmission using IM/DD, e.g. a 40 Gbps IM/DD data channel is emitted via two (or n) physically separate DWDM channels (or in one 100 GHz DWDM channel), and it has to be ensured that the spectrums of the two diversity channels belonging to one data channel do not overlap (this is also the case with all low-rate transmissions, where, however, the spectral bandwidth efficiency is irrelevant). Should the optical spectrums overlap, perturbations of the signal quality will result (crosstalk by mixing the overlapping spectral portions with beat-like effects in the partial region, the received signal is thereby deteriorated or even useless, depending on the degree of overlap). In a multi-channel (DWDM) transmission, the Tx-Div thus compels the required optical bandwidth to be a multiple of the data rate (to avoid overlap). This may have the effect that the available spectrum in total is not sufficient to transmit the required data rates. For example, a 40 Gbps data signal requires two 100 GHz physical DWDM channels, i.e. 200 GHz of physical bandwidth per 40 Gbps of effective user data rate, which limits the overall rate to 640 Gbps given the typically technically available 32 DWDM channels. Using optimized filters and demultiplexers, the channels could possibly be closer to each other, yet the basic limitation that with Tx-Div a multiple of the bit rate is required, remains.

Besides the use of different wavelengths for the separation of the individual channels, DE 10 2015 221 283 A1 proposes to transmit a single side band modulation signal with each transmission beam “Tx”, which signal is superimposed at the receiver to form a dual side band modulation signal. This also reduces interferences with the transmission. However, this method is restricted to two diversity channels. Further, it is an incoherent modulation method, like the method using separation via the wavelength.

DE 10 2014 213 442 A1 describes the use of different polarizations for the transmitter diversity. Here, a destructive superimposition of the individual transmission beams is prevented due to differing polarizations. However, also in this case, there is a restriction to two diversity channels.

WO 2005/002102 A2 describes an optical free-beam communication system with a transmitter having a plurality of data channels, each of the data channels using a different wavelength. The data channels are then combined in a multiplexer and transmitted to a receiver.

It is an object of the present invention to provide a transmitter for an optical free-beam communication system, as well as an optical free-beam communication method, which have an improved spectral efficiency and a scalable transmitter diversity.

The object is achieved according to the invention with the features of claim 1, as well as of claim 9.

The present transmitter for an optical free-beam communication system, in particular for a data uplink to a satellite for emitting a light signal, has a number of m data channels. Each data channel has a different wavelength. Thus, the m data channels comprise exactly m wavelengths. In particular, the data channels are generated by a carrier light of a certain wavelength being superimposed with the bit sequence of the data to be transmitted, using a modulator. According to the invention, a multiplexer is provided for superimposing the m data channels into a sum signal. The multiplexer is connected with a number of n pulse devices, wherein the respective pulse devices form a pulse signal from the sum signal. Thereby, n pulses are generated from the sum signal. Specifically, when a pulse signal of the n-th pulse device is emitted, a pulse signal of the first pulse device will be emitted subsequently etc., so that pulse signals are generated in turn or periodically by the n pulse devices. Here, the pulse signals offset in time with respect to each other, such that no two pulses are present at the same time in one time domain. Each pulse device is connected with a respective transmitter device for transmitting the respective pulse signal. Thus, the number of transmitter devices is also n.

The basic idea of the invention thus is to use a time separation of the individual diversity channels to avoid interferences at the receiver side. The n transmitter devices always emit the same bit stream, but successively in short pulses. The spectra of the respective pulse signals are widened because of the necessary shortening by the pulse devices. However, when the respective pulse signals are superimposed in the receiver, the spectral widening can substantially be reversed. Thus, the spectral efficiency is better when compared to other Tx-Div methods. The reason is that in the present invention the same carrier is used for all diversity channels and the same sum up coherently at the receiver, whereby the spectral width is reduced to almost the original width of the single data signal. Further, the transmitter of the invention is scalable and allows for a single transmitter diversity and, different from the methods described above, is not restricted to two diversity channels. Thus, a plurality of data channels can be transmitted at the same time, if a plurality of transmitter devices is used at the same time.

It is a further advantage of the present invention that only one carrier is used for all diversity channels, so that a coherent demodulation can be performed at the receiver side. The transmitter structure is less expensive and more robust, since only one source has to be implemented per channel, instead of a plurality of sources.

The pulse amplitude increase due to the generation of the pulse signal so that a higher overall amplitude can be received at the receiver.

The complexity of the system resides at the transmitter side, where the respective pulse signals have to be generated, as well as in the generation of the sum signal. In contrast to that, a conventional DWDM receiver is sufficient at the receiver side (e.g. the satellite).

Preferably the number m of the data channels is at least 1. However, a significantly greater number of data channels can be transmitted by the transmitter of the invention, so that the number m of the data channels is in particular >50. Thus, the present invention is freely scalable and is merely restricted to the existing band width of the DWDM channels used.

The number n of the pulse devices and, correspondingly, the number n of the transmitter devices is at least 2. At least two transmitter devices are required to obtain a transmitter diversity and to thereby reduce interferences with the signal during transmission.

Due to the relation SI(n)=SI(1)/n_{Tx} it is expected that the scintillation will halve when two transmitters are used. If n>2 is selected, scintillation is reduced correspondingly further. Thus, atmospheric influences on the transmission of the light signal can be reduced further.

Preferably the pulse signals are amplified. Besides a reduction of the fluctuations, transmitter diversity allows for an increase of the overall power emitted. The same may be limited per transmitter telescope e.g. for technical reasons (for example, because of the thermal capacity of the transmission fiber or other components or because of the eye safety of the transmission system). By distributing the power over a plurality of transmitters, these technical limitations can be countered efficiently.

The sum of the lengths of the pulses is preferably equal to the length of the original data bit. Thus, it is made sure that the complete data bit is covered by the respective pulse signals, each pulse signal comprising only a section of the original data bit or of the sum signal.

Preferably the length of the respective pulse signal m corresponds to 1/n of the length of the original data bit. If n pulse devices are provided, the original data bit is thus split into n pulses which all have the same length, namely 1/n of the length of the original data bit.

The offset in time between the individual pulse signals is preferably generated by optical waveguides of different lengths or by modulators which are triggered using a corresponding pulse source.

The transmitter devices are preferably spaced from each other by a distance that is greater than the structure sizes of turbulence cells in the optical free-space transmission, so that the signal is transmitted via different atmospheric paths. For example, the transmitter devices can be spaced apart by 20 cm and in particular by 1 m, so that the signal is transmitted via different atmospheric paths. The n signals are combined at the receiver, so that scintillation is reduced.

Preferably all data channels have a common data carrier. Thereby it is possible to use a coherent demodulation at the receiver side.

The data signal is preferably modulated using IM/DD (NRZ pulse modulation) or using a coherent format such as e.g. selfhomodyne DPSK, BPSK, ASK heterodyne or the like.

The transmitter of the invention can be used in particular for a data uplink to a satellite from a ground station. The same may be a LEO or a GEO satellite.

Further, the transmitter of the invention may be used in an optical uplink to an airplane/OAVs/HAPs from an optical ground station. Ground-to-ground communication is also conceivable. The same may be used e.g. for linking building LANs to the Internet or for linking mobile base stations. Far-reaching FSO links (up to 20 km) may in the future also be used as communication backbones. Especially, if the fading problem can be solved.

Further, an implementation in optical inter-HAP links is possible. These future stratospheric communication platforms will be linked advantageously by optical directional radio, the distance of up to several 100 km entailing a propagation time which has adverse effects in case of several repetition requests (ARQ).

The transmitter of the invention may further be used for an optical transmission of frequency standards for the synchronization of optical clock.

The invention further relates to a free-beam communication system, in particular for a data uplink to a satellite, with a transmitter as described above and a DWDM receiver, e.g. in a satellite.

The receiver preferably comprises a receiver device for receiving the light signal emitted from the transmitter, as well as a demultiplexer for the wavelength-selective splitting of the received light signal, the demultiplexer being connected with the receiver device. A number of m detectors is connected with the demultiplexer to receive the respective data channel. Here, each detector receives a data channel at a specific wavelength. The light signal received consists of the superimposition of all pulse signals generated by the transmitter. Thus, the receiver has a simple structure. In particular, no increased bandwidth is required for the receiver. The receiver has to regard neither the pulses, nor the number of diversity channels; the stage of this transmitter diversity can thus also be modified dynamically (or per link partner), without the receiver having to react thereto.

The invention will be explained in more detail with reference to preferred embodiments and to the accompanying drawings.

In the Figures:

FIG. 1 shows the basic functionality of a transmitter diversity,

FIG. 2 shows an exemplary received power vector received at the satellite,

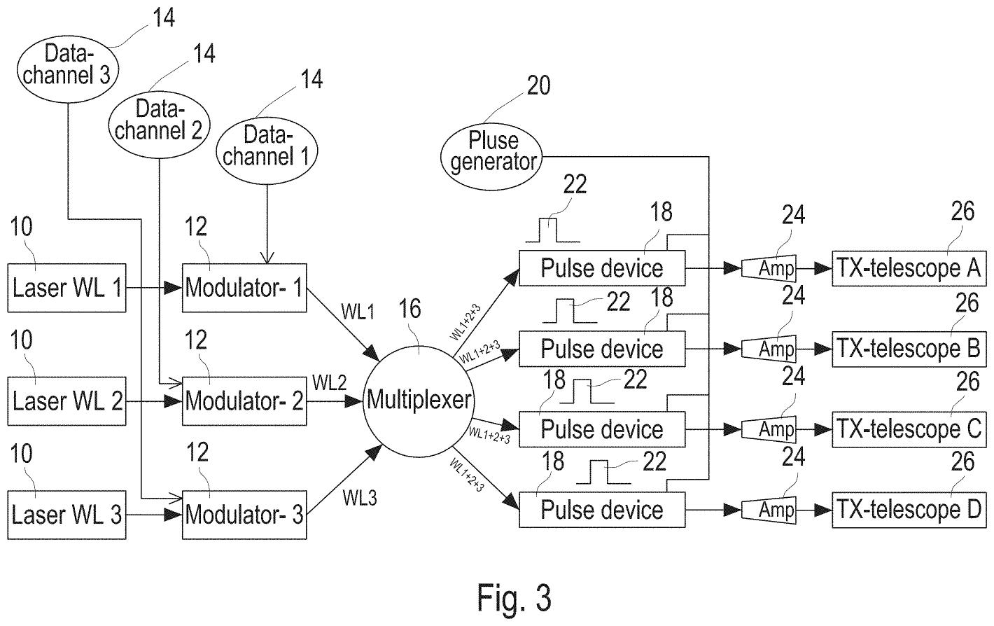

FIG. 3 shows an embodiment of the transmitter according to the invention,

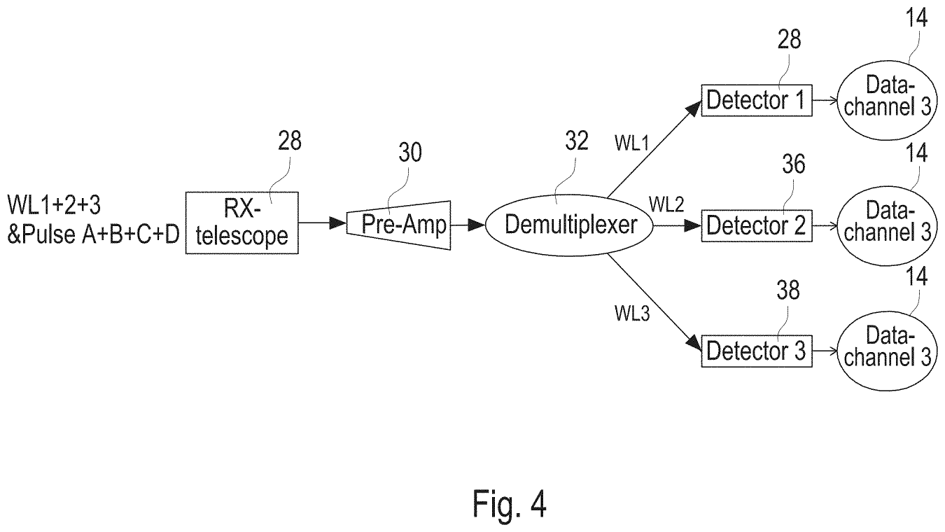

FIG. 4 shows a receiver of the free-beam communication system of the present invention,

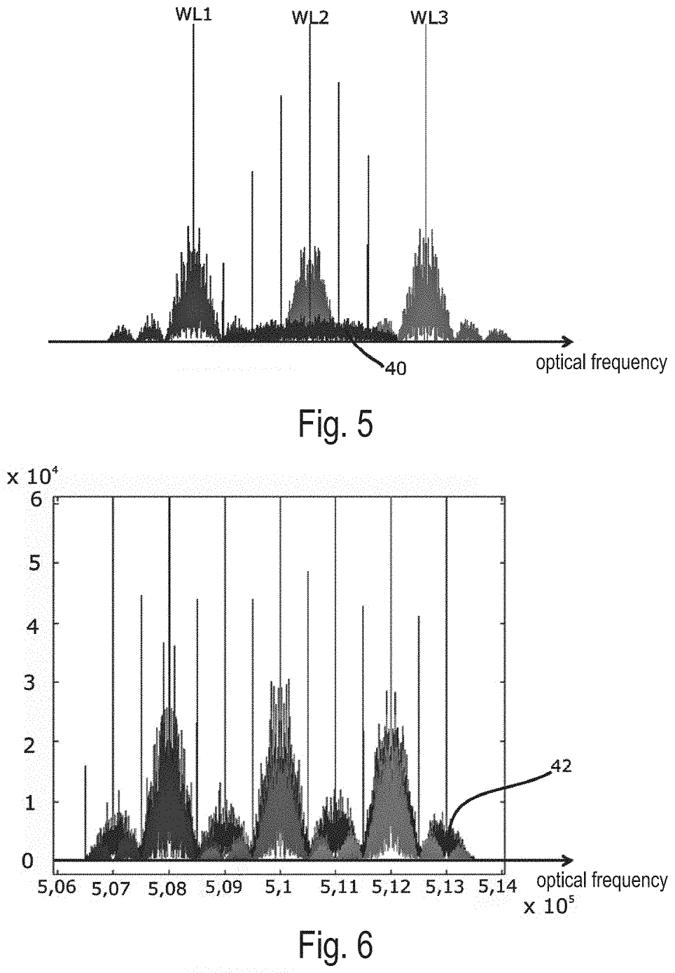

FIG. 5 shows a spectrum of the light signal at the transmitter side, and

FIG. 6 shows a spectrum of the received light signal at the receiver side.

FIGS. 1 and 3 were already discussed in the context of prior art.

FIG. 3 shows an embodiment of the transmitter of the present invention which has three data channels (m=3) and four pulse devices (n=4). The device has three laser light sources 10 for generating laser light with a first wavelength WL 1, a second wavelength WL 2 and a third wavelength WL 3. Here, the wavelengths of the lasers 10 differ from each other. In a modulator 12, the respective laser light of the laser 10 is superimposed with a data channel 14. Here, the number of data channels corresponds to the number of wavelengths used. The data channel having the first wavelength WL 1, the data channel having the second wavelength WL 2 and the data channel having the third wavelength WL 3 are combined into a sum signal in a multiplexer 16, which sum signal is supplied to four pulse devices 18. Here, all pulse devices 18 receive the same sum signal. In the embodiment illustrated the pulse devices 18 are each modulators which are controlled via a pulse source 20 so as to form a pulse signal from the sum signal. Here, the pulse signals all have the same length and are offset in time with respect to each other, as illustrated by the indicated trigger pulse 22 in FIG. 3. The length of the pulses 22 corresponds to just 1/n=¼ of the original bit length. Thus, the first quarter of the original bit is detected by the first pulse device 18, the second quarter of the original bit is detected by the second pulse device 18, etc.

The pulse signals are amplified in an amplifier 24. Subsequently, each pulse signal is emitted via a dedicated transmission telescope 26. The transmission telescopes 26 are spaced from each other by a distance that is greater than the structural size of the turbulence cells of the optical free-beam transmission, in particular the atmosphere. Here, each transmission telescope 26 emits the same signal, but at different times due to the offset in time of the pulse signals with respect to one another.

The pulse signals emitted via the transmission telescopes 26 become superimposed to form a light signal consisting of the three wavelengths WL 1, WL2 and WL3, and are received by a receiving telescope 28 at the receiver side, as illustrated in FIG. 4. The light signal received is pre-amplified in a pre-amplifier 30. Thereafter, the received light signal is split into the wavelengths WL 1, WL 2 and WL 3 in a demultiplexer 32. The first wavelength WL 1 is detected by a first detector 34, the second wavelength WL 2 is detected by a second detector 36 and the third wavelength WL 3 is detected by a third detector 38. Using the detectors 34, 36, 38, it is possible to extract the bit data sequence of the data channels 14 that was to be transmitted originally.

In FIG. 5 the spectra of the three wavelengths WL 1, WL 2 and WL 3 are plotted. Due to the generation of short pulses of the pulse signal by the pulse devices 18, the spectrum of a respective pulse 40 is widened, also illustrated in FIG. 5, but for the wavelength WL 2 only. During superimposition in the receiver, the pulses of the respective wavelengths are added (spectrum 42), the sum spectrum having a width that substantially corresponds to the width of the spectrum of the three wavelengths WL 1, WL 2 and WL 3. Thus, using transmitter diversity, a plurality of data channels can be efficiently transmitted. A restriction to merely two data channels does not exist.

1. A transmitter for an optical free-beam communication system, in particular for a data uplink to a satellite, for emission of a light signal, comprising;
a number of m data channels, the data channels each having a different wavelength,
a multiplexer for superimposition of the m data channels into a sum signal,
a number of n pulse devices, a pulse signal being formed from the sum signal by respective pulse devices, the pulse signals being offset in time from each other, and
a number of n transmission devices, each transmission device being connected with a pulse device for emitting respective pulse signals.

2. The transmitter of claim 1, wherein the number m of the data channels is larger than 50.

3. The transmitter of claim 1, wherein the number n of the pulse devices and the number n of the transmission devices is at least 2.

4. The transmitter of claim 1, wherein an amplifier is provided for amplifying the pulse signal.

5. The transmitter of claim 1, wherein a sum of one or more lengths of the pulse signals equals a length of an original data bit.

6. The transmitter of claim 1, wherein a length of a respective pulse signal equals 1/n of a length of an original data bit.

7. The transmitter of claim 1, wherein a chronological offset between individual pulse signals is generated by optical waveguides of different lengths.

8. The transmitter of claim 1, wherein the transmission devices are spaced by a distance that is greater than a structural size of turbulence cells in an optical free-beam transmission, so that the light signal is transmitted via different atmospheric paths, the devices being spaced apart in particular by a distance of more than 20 cm.

9. A free-beam communication system for a data uplink to a satellite, comprising
a transmitter according to claim 1, and
a DWDM receiver.

10. The free-beam communication system claim 9, wherein the receiver has a receiving device for receiving the light signal emitted by the transmitter, a demultiplexer for wavelength-selective splitting of the received light signal, the demultiplexer being connected with the receiving device, and a number of m detectors for receiving the respective data channel, each detector receiving one wavelength of the light signal.

11. The free-beam communication system of claim 9, wherein the respective data channels are modulated using IM/DD, selfhomodyne DPSK, BPSK or ASK heterodyne.
